(19) United States
(12) Patent Application Publication
(10) Pub. No.: US 2015/0055008 A1
(43) Pub. Date: Feb. 26, 2015

(54) Systems and methods of saving power by adapting features of a device

(71) Applicant: QUALCOMM Incorporated, San Diego, CA (US)

(72) Inventor: Khosro Mohammad Rabii, San Diego, CA (US)

(21) Appl. No.: 14/532,873

(22) Filed: Nov. 4, 2014

Related U.S. Application Data
(63) Continuation of application No. 13/089,012, filed on Apr. 18, 2011.

(51) Int. Cl. H04N 5/232; H04N 5/14

(52) U.S. Cl. CPC H04N 5/23241; H04N 5/23296; H04N 5/145
USPC 348/333.13

(57) ABSTRACT

Present embodiments contemplate systems, apparatus, and methods to reduce power consumption of devices. Particularly, present embodiments contemplate modifying parameters of embedded components, including imaging sensors and electronic displays, to reduce power consumption. By modifying parameters of these components in an intelligent manner, the full capabilities of these components are available when needed by a device user, while power is conserved by reducing the capabilities of the components when those capabilities are not needed to support a current use of the device.

### TECHNICAL FIELD

The present embodiments relate to mobile devices, and in particular, to methods, apparatus, and systems for reducing the power consumption of those devices. These methods, apparatus, and systems prolong battery life by tailoring features and capabilities of individual device components to the current operational conditions of the devices.

### BACKGROUND

A wide range of mobile electronic devices, including mobile wireless communication devices, personal digital assistants (PDAs), personal music systems, digital cameras, digital recording devices, and the like, make use of display and/or camera devices to provide imaging capabilities and features.

Technological advances of displays and digital cameras continue to increase the capability of these mobile devices. The first camera phones had a one megapixel resolution. In early 2011, camera phones with resolutions of five megapixels are common, with high end phones supporting twelve megapixels or more. Trends in mobile display technologies are similar. In the year 2000, monochrome screens with an 84×48 pixel resolution were common Today, the popular iPhone® 4 has a display resolution of 960×640 pixels. Other smart phones provide similar display capabilities. These improvements in hardware technological capability are paired with corresponding improvements in software to provide powerful features for today's mobile device user, including web browsing, video conferencing, and high resolution photo capture and sharing.

While mobile device capabilities have increased, so has their power consumption. Several existing techniques are available to mitigate power consumption on mobile devices, including timeouts that turn off a screen or camera system after a certain period of inactivity. However, the increasing power demands of high capability displays and cameras threaten to impact usable battery life of mobile devices unless additional power-saving measures are taken.

### SUMMARY

Some of the present embodiments may comprise a method of managing the capabilities of an imaging device having a camera sensor and a display. The method may include analyzing a plurality of frames received by an imaging module from a camera sensor to detect motion in a scene. The method may further include making a first adjustment to a feature of the imaging device if no motion is detected in the scene, while maintaining sufficient power to the imaging module so as to continue detecting motion in the scene. The method may further include making a second adjustment to a feature of the imaging device if motion is detected in the scene. In some embodiments, the first adjustment reduces the power consumption of the device and the second adjustment increases the power consumption of the device. In other embodiments, the first adjustment comprises at least one of reducing the resolution of the camera sensor, reducing the frame rate of the camera sensor, reducing the frame rate of a display, or reducing the contrast ratio of a display. In certain embodiments, the method may further include generating an interrupt based on whether motion is detected. In other embodiments, the method may include adjusting a feature based on the interrupt. In some embodiments, the method may further include obtaining a plurality of measurements from an accelerometer, and determining a device usage based on the plurality of measurements, wherein the first adjustment is also based on the device usage. Certain other embodiments may further comprise obtaining a device orientation from a sensor, wherein the first adjustment or the second adjustment is also based on the device orientation. In other embodiments, the first adjustment may include reducing the sampling rate of a geolocation receiver.

Some embodiments may include a method of managing power consumption of an imaging device, comprising monitoring values of an accelerometer, determining a device usage level based on the values, and adjusting a feature of the imaging device based at least in part on the device usage level to manage the power consumption of the device.

Some embodiments may include an imaging apparatus, including a camera sensor and an image processing module configured to detect motion in a scene captured by the camera sensor, make a first adjustment to a feature of the imaging apparatus if no motion is detected in the scene, maintain sufficient power to the image processing module so as to continue detecting motion in the scene, and make a second adjustment to a feature of the imaging apparatus if motion is detected. In certain embodiments, the first adjustment includes at least reducing the resolution of the camera sensor or reducing the frame rate of the camera sensor. Other embodiments further comprise a detector, wherein either the first adjustment or the second adjustment is also based on input from the detector. In other embodiments, the detector is an accelerometer or an orientation detector. In certain embodiments, the apparatus further comprises a display, wherein the first adjustment or the second adjustment may comprise modifying a parameter of the display. In certain other embodiments, the parameter is the display frame rate. In other embodiments, the parameter is the display contrast ratio. In embodiments where the detector is an accelerometer, the imaging processing module is further configured to modify a parameter of the display when a lack of motion is detected in a predetermined time.

Other embodiments comprise a non transitory computer-readable medium containing processor executable instructions that are operative to cause a processor to detect motion in a scene, make a first adjustment of a feature of an imaging device if no motion is detected in the scene, maintain sufficient power to an image processing module so as to continue detecting motion in the scene, and make a second adjustment of a feature of the imaging device if motion is detected. In other embodiments, the first adjustment comprises reducing the resolution of a camera sensor. In other embodiments, the first adjustment comprises reducing the frame rate of a camera sensor.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1 is a generalized block diagram depicting one embodiment of a device implementing the invention disclosed herein. The major components of a mobile device are illustrated.

FIG. 2 illustrates data flows between the major modules of a mobile device implementing certain present embodiments.

FIG. 3 is a flowchart depicting several steps found in the device manager module of mobile devices implementing certain embodiments.

FIG. 4 is a flowchart depicting several steps found in the motion sensing module of mobile devices implementing certain embodiments.

FIG. 5 is a flow chart depicting several steps found in the display manager module of mobile devices implementing certain embodiments.

FIG. 6 is a flow chart depicting several steps found in the sensor manager module of mobile devices implementing certain embodiments.

### DETAILED DESCRIPTION

Implementations disclosed herein provide systems, methods and apparatus for reduced power consumption in a mobile electronic device. Particularly, some embodiments contemplate adjusting features of the mobile device based on the level of motion detected through a camera sensor. One skilled in the art will recognize that these embodiments may be implemented in hardware, software, firmware, or any combination thereof.

Thus, one embodiment is a mobile electronic device that includes power saving features based on detecting motion. For example, in one device the camera sensor detects motion of a scene. After a predetermined time of no detected motion, the electronic device powers down selected components, such as the display. A core application may continue to run on a processor of the device, but in the background, analyzing camera sensor input to sense when motion is again detected. Once motion is detected, the device can reinitiate selected components, such as the display. In one embodiment, the core application reads a portion of the input from the camera sensor, for example a lower resolution of the sensor data, in order to preserve energy. For example, the core application may analyze 5%, 10%, 20%, 30%, 40% or 50% of the pixels obtained by the camera sensor in order to detect motion.

In the following description, specific details are given to provide a thorough understanding of the examples. However, it will be understood by one of ordinary skill in the art that the examples may be practiced without these specific details. For example, electrical components/devices may be shown in block diagrams in order not to obscure the examples in unnecessary detail. In other instances, such components, other structures and techniques may be shown in detail to further explain the examples.

It is also noted that the examples may be described as a process, which is depicted as a flowchart, a flow diagram, a finite state diagram, a structure diagram, or a block diagram. Although a flowchart may describe the operations as a sequential process, many of the operations can be performed in parallel, or concurrently, and the process can be repeated. In addition, the order of the operations may be re-arranged. A process is terminated when its operations are completed. A process may correspond to a method, a function, a procedure, a subroutine, a subprogram, etc. When a process corresponds to a software function, its termination corresponds to a return of the function to the calling function or the main function.

Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

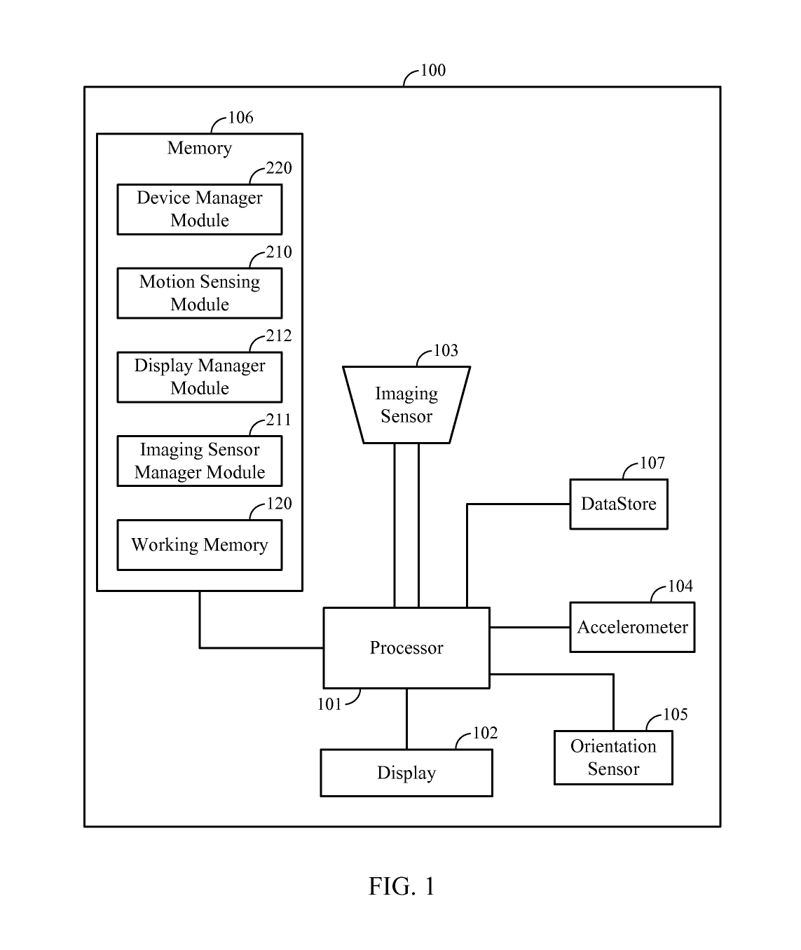

FIG. 1 depicts a high-level block diagram of a mobile device 100 comprising a set of components including a processor 101, a display 102, an imaging sensor 103, an accelerometer 104, an orientation sensor 105, a memory 106, and a data store 107. Mobile device 100 may comprise a cell phone, digital camera, personal digital assistant, or the like. Mobile device 100 may comprise a camera or include other means for receiving images, such as a USB, WI-FI, or Bluetooth connection. A plurality of applications may be available to the user on mobile device 100. These applications may include messaging services, image capture applications, internet browsing, video conferencing, and other common applications known to one skilled in the art. Some of the applications on mobile device 100 may operate on images received from a remote location, or operate upon images generated locally by mobile device's camera sensor. In some embodiments, data-store 107 may comprise a built in memory, such as a non-volatile RAM, with flash RAM being one example. Alternatively, data-store 107 may include removable memory such as a compact flash card, memory stick, or the like. In other embodiments, the mobile device may connect to a data store over an external interface (not shown) such as a USB, IEEE 1394, or the like. Mobile device 100 may also comprise additional components not shown including an external power connector, geo-location receiver such as a GPS receiver, a radio receiver, or a cellular receiver/transmitter.

Processor 101 may be a general purpose processing unit or a processor specially designed for imaging applications. As discussed above, the processor is configured by several modules stored in a memory. In the illustrated embodiment, memory 106 stores a motion sensing module 210, display manager module 212, and image sensor manager module 211. These modules configure the processor 101 to receive image frames from the imaging sensor 103. The image frames may be at least temporarily stored in the working memory, which may utilize dynamic RAM technology, while the processor analyzes the image frames. The processor 101 is configured by the motion sensing module 210 to detect motion from the frames received from the imaging sensor 103. Based on the amount of motion detected, the image sensor manager module 211 configures the processor 101 to adjust image sensor parameters as appropriate for the amount of motion detected. The display manager module 212 configures the processor 101 to adjust parameters of the display component 102 as appropriate for the given amount of motion detected. In some embodiments, the display manager module 212 and/or the image sensor manager module 211 may configure the processor 101 to read device orientation from the orientation sensor 105, and to read device motion from the accelerometer 104. The display manager module 212 and image sensor manager module 211 utilize the input from the accelerometer 104 and orientation sensor 105 to determine appropriate settings for their respective device components.

Although FIG. 1 depicts a mobile device, one skilled in the art will recognize that the present embodiments may also apply to any imaging system. A desktop system, comprising local image storage, for example, may also implement many of the present embodiments as part of locally running imaging processes.

Furthermore, although FIG. 1 depicts a mobile device comprising separate components to include a processor, imaging sensor, display, data store, accelerometer, and orientation sensor, one skilled in the art would recognize that these separate components may be combined in a variety of ways to achieve particular design objectives. For example, in an alternative embodiment, the accelerometer and orientation sensor may be combined to reduce component cost. In another embodiment, memory components may be combined with processor components to save cost and improve performance.

Alternatively, other embodiments may separate the individual functional components illustrated into additional components. For example, some embodiments may employ more than one processor. In those embodiments, a subset of the motion sensing module 210, display manager module 212, and image sensor manager module 211 may configure one processor, with the remaining modules configure other processors. Alternatively, all modules may be enabled to configure all processors, with an operating system dispatcher determining when each module configures or runs on each processor. One skilled in the art would recognize the variety of embodiments possible in this area would not represent a departure from the invention disclosed herein.

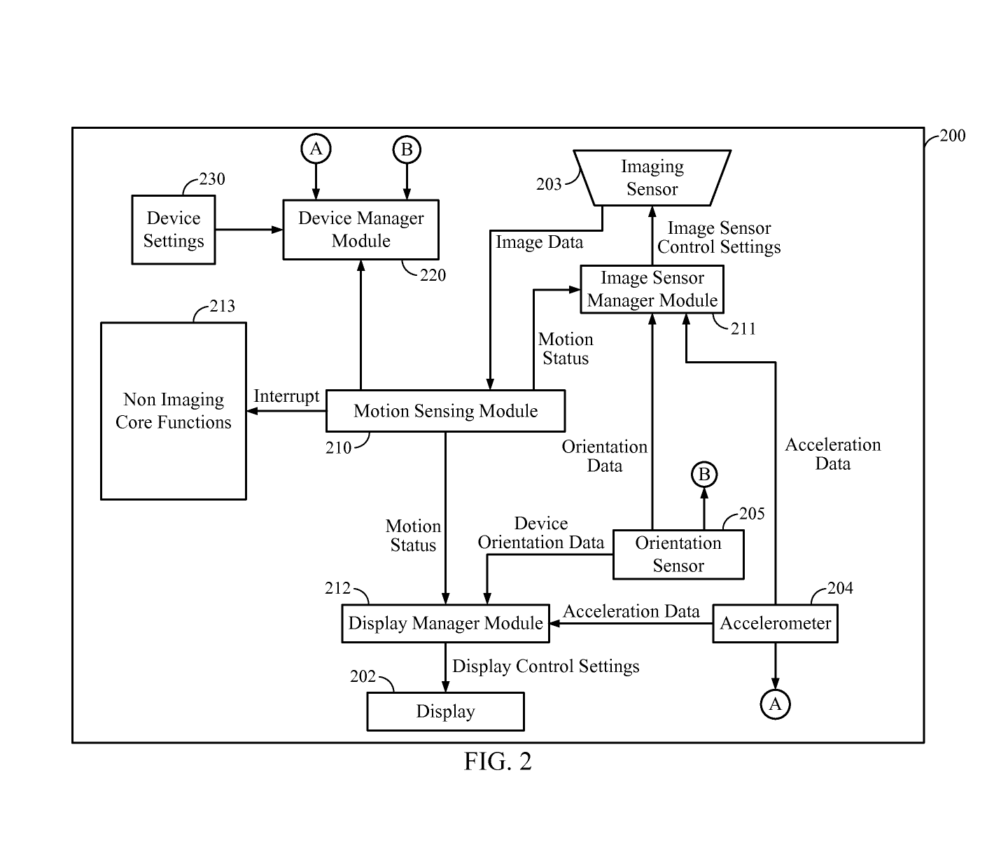

Furthermore, although FIG. 1 illustrates a memory component 106 comprising several modules and a working memory 120, one with skill in the art would recognize several alternative embodiments utilizing different memory architectures. As shown, the memory 106 includes a device manager module 220, motion sensing module 210, an imaging sensor manager module 211 and a display manager module 212. The functions of these modules are described more completely with reference to FIG. 2 below. In some embodiments, a design may utilize ROM or static RAM memory for the storage of processor instructions implementing the motion sensing module 210, display manager module 212, and imaging sensor module 211. Lower cost dynamic access memory (RAM) may be utilized to implement the working memory component 120. Alternatively, processor instructions may be read at system startup from a disk storage device integrated with mobile device 100 or connected via an external device port. The processor instructions may then be loaded into RAM to facilitate execution by the processor.

Varying groups of components illustrated in FIG. 1 may be considered by one with skill in the art to be an imaging pipeline or imaging module. For example, the processor 101, imaging sensor 103, and a memory 106 comprising the imaging sensor manager module 211 and motion sensing manager module 210 may be considered an imaging module or image pipeline in some embodiments. Such an embodiment of an imaging module provides sufficient functionality to detect motion in a scene. In alternate embodiments, the imaging pipeline or image module may further comprise the display 102 and a memory comprising the display manager module 212. Such an imaging pipeline provides the ability for live images to be captured by the imaging sensor and displayed on the display.

FIG. 2 illustrates the data flow between components of one embodiment of the mobile device 100. These components function cooperatively to implement some embodiments of the power saving features of mobile device 100. First, data flowing from the imaging sensor 203 is sent to the motion sensing module 210. The data may comprise a bit stream having image frames captured by the imaging sensor. Instructions in the motion sensing module 210 analyze the image frames to detect motion and determine a current motion status for the scene viewed by the imaging sensor 203. The motion sensing module 210 then provides the current motion status to the image sensor manager module 211, the display manager module 212, and the device manager module 220. The motion sensing module 210 may also interrupt non imaging core functions of the device when a change of motion is detected.

One skilled in the art will recognize that the invention is not limited to an embodiment utilizing a particular technique to provide data to the image sensor manager module 211 and display manager module 212. For example, the image sensor manager module 211 and display manager module 212 may “poll” the motion sensing module 210 to retrieve a current motion status. Alternatively, the motion sensing module 210 may “push” data to the display manager module 212 and image sensor manage module 211 as it is determined

When motion status is received from the motion sensing module 210, instructions in the image sensor manager module 211 determine whether the motion status falls within thresholds established for the current set of imaging sensor parameters. Imaging sensor parameters may include image sensor resolution, image sensor frame rate, image sensor color depth, or image sensor power state (powered on or powered off for example). Embodiments utilizing different sensors support parameters corresponding to the particular sensor utilized.

If the current motion status falls within the thresholds for the current imaging sensor parameters, the image sensor manager module 211 may take no action. Alternatively, if the current motion status falls outside the thresholds for the current imaging sensor parameters, the image sensor manager module 211 may send imaging sensor 203 updated configuration parameters.

As a further power saving measure, the image sensor manager module 211 may turn off the imaging sensor 203 altogether when the device is in certain orientations, for example if the imaging sensor is pointed downwards towards a surface. To facilitate this, the image sensor manager module 211 receives device orientation data from an orientation sensor 205 in some embodiments. The imaging sensor manager module 211 may also receive data from an accelerometer 204 or other device for detecting the position of the device 100. In some embodiments the imaging sensor manager module 211 detects whether the device is in a horizontal or a vertical position. In other embodiments, the imaging sensor manager module 211 detects whether the device is resting at a particular angle relative to the ground.

The display manager module 212 also receives motion status from the motion sensing module 210. Similar to the image sensor manager module, the display manager module 212 compares the current motion status provided by the motion sensing module 210 to thresholds established for the current set of display parameters. Display parameters may include display resolution, display frame rate, display dithering modes, display color depth, and display power state. Additional display parameters may be appropriate depending on the specific type of display included in mobile device 100. For example, color and monochrome displays may support different parameter sets. When the current motion status is outside thresholds established for current display parameters, the display manager module 212 may update display parameters of a display 202.

In certain embodiments, the display manager module 210 may also acquire device orientation data from the orientation sensor 205. In other embodiments, the orientation data may be used in combination with acceleration data obtained from an accelerometer 204. Data from these sensors will also be compared against thresholds established for current display parameters, with adjustments made to display parameters as necessary.

The device manager module 220 also receives motion status from the motion sensing module 210. Instructions in the device manager module 220 utilize input from the motion sensing module 210 to determine whether to place the device into a stand by mode. The device manager module 220 instructions may also receive input from the orientation sensor and accelerator to assist with the determination of whether to place the device into a stand-by mode.

In some embodiments, the motion sensing module 210 may send an interrupt notifying non-imaging core functions 213 of the level of motion detected. This capability enables significant power savings in some device embodiments. In some embodiments, components waiting for an interrupt may operate in a state of significantly reduce power consumption when compared to the power consumed to maintain a traditional firmware or software based communication design.

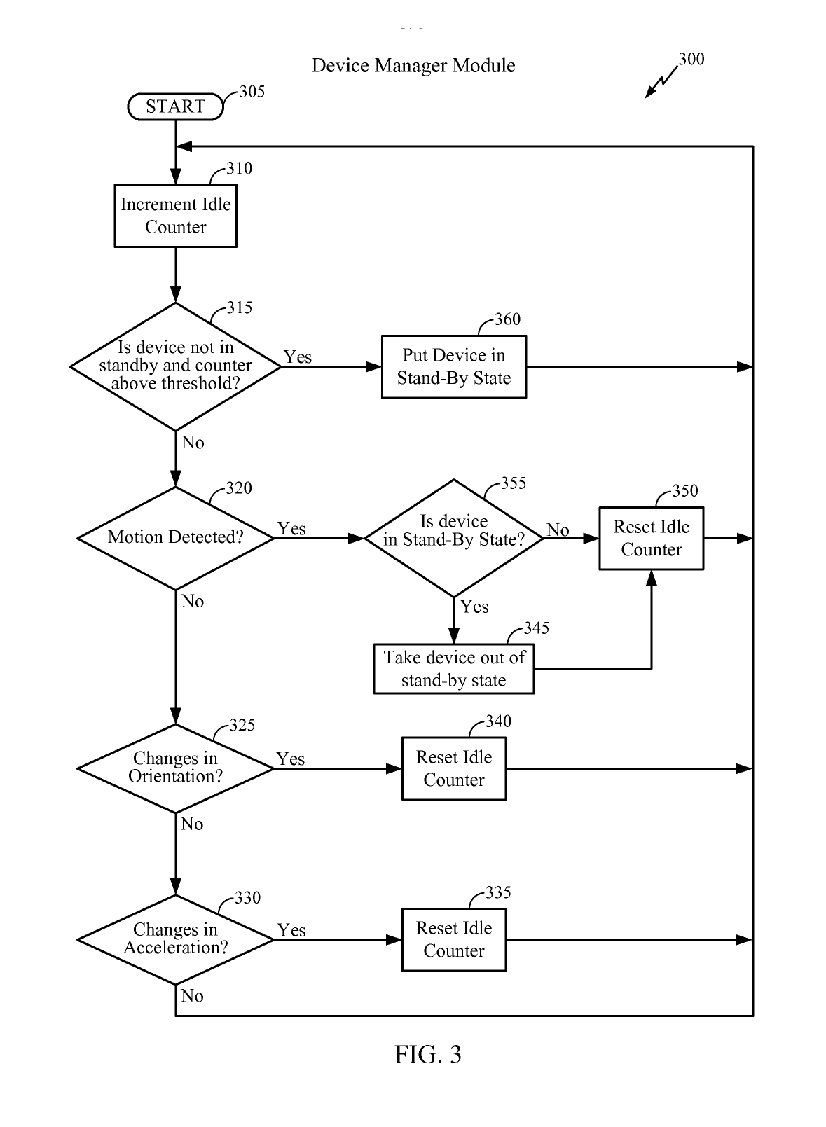

FIG. 3 is a flow chart illustrating a process 300 that runs within one embodiment of the device manager module 220. The process 300 begins at a start state 305 and then moves to state 310 to increment an idle counter. Process 300 then moves to decision step 315, where it determines if the device is not in a stand by state and whether the idle counter is above the idle threshold for placing the device in a stand by state. If the counter is above the threshold and the device is not in a standby mode, process 300 moves to state 360 and the device is placed in a stand-by state. Process 300 then returns to step 310 and the process 300 repeats.

If the counter is below the threshold in decision step 315, process 300 moves to decision step 320, where step 320 evaluates whether motion has been detected since the last time it was invoked. If motion is detected, process 300 then moves to decision state 355 to determine whether the device is currently in a stand-by state. If the device is not currently in a stand-by state, then process 300 moves to state 350, where the idle time counter is reset. Process 300 then returns to step 310 and the process 300 repeats.

If the device was in a stand-by state, process 300 moves to step 345 from decision state 355. In state 345, the device is removed from the stand-by state. Process 300 then moves to step 350, and the idle time counter is reset as discussed previously, with process 300 then returning to step 310.

If no motion is detected in step 320, process 300 moves to decision step 325. Step 325 determines if there have been any changes in orientation. If changes in orientation are detected, process 300 moves to step 340, where the idle counter is reset. The process 300 then returns to state 310 and the process 300 repeats. If no changes in orientation were detected in decision step 325, process 300 moves to step 330 where changes in acceleration are evaluated. If changes in acceleration are detected in step 330, process 300 moves to state 335 where the idle time counter is reset. Process 300 then returns to state 310 and the process 300 repeats.

When placing the device into a stand-by state, portions of the device are powered down to save power and extend battery life. For example, non imaging core functions 213 may be powered off completely. Process 300 places the device in a stand by state at least partially due to a lack of motion detected through the imaging sensor. (See above step 320). In the illustrated embodiment however, the device manager continues to monitor motion after the device is placed into the stand by state, so if motion is later detected, the device can be brought out of the stand by state. To accomplish this, the device manager must maintain sufficient power to the imaging sensor 203, the motion sensing module 210, and its own processing resources such that the device may continue to detect motion while in the stand by state. Thus, the instructions in the device manager module that maintain power to the processor, memory resources, and an imaging sensor while the device is in a standby state represent one means for maintaining sufficient power to an imaging module so as to continue detecting motion in a scene.

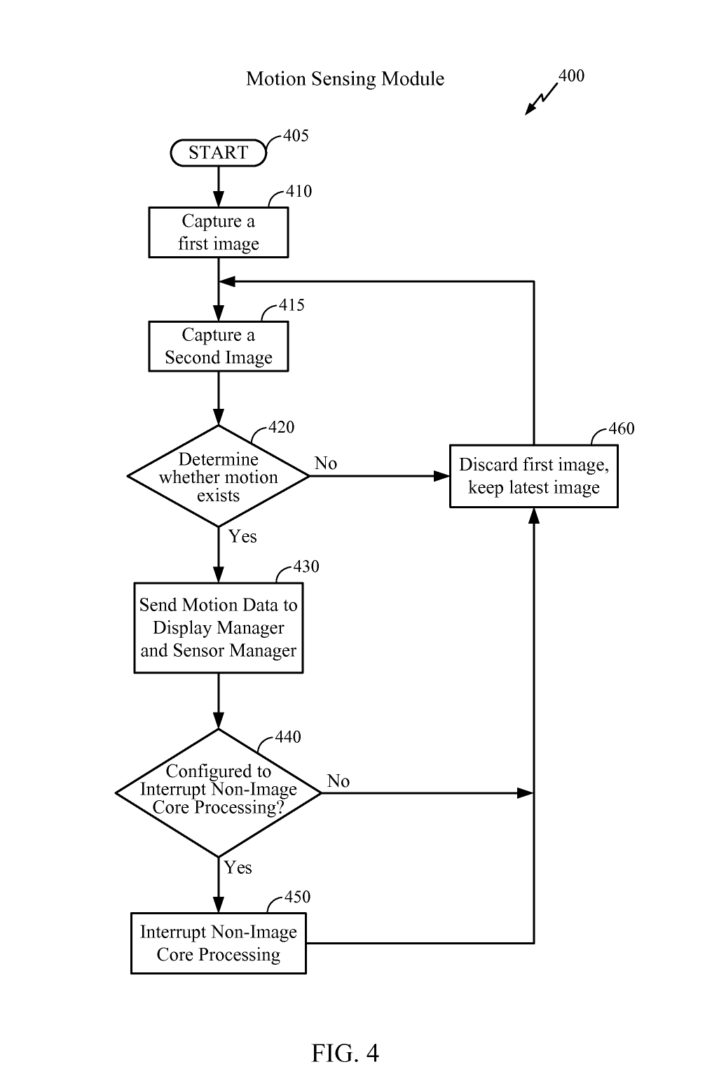

FIG. 4 is a flow chart illustrating a process 400 that runs within one embodiment of the motion sensing module 210. The motion detection process 400 begins at a start state 405 and then moves to capture a first image from a camera sensor in step 410. After some period of time, the process 400 captures a second image in step 415.

The period of time between the capture of the first image in step 410 and the second image in step 415 is set based on a number of factors. For example, if the imaging device is designed for an environment that uses shorter response times to motion, then a shorter time between frame captures is appropriate. An example of such an environment might include a red light camera, where any detected motion may be captured before a vehicle passes out of frame or other important data as to vehicle speed or position is unavailable. Alternatively, some security applications may tolerate longer delays between frames, especially if objects imaged are at a distance. Similarly, the relative motion of imaged objects may influence the period of time between frames. With fast moving vehicles, a small interval between frames may be needed. Imaging slower moving objects, such as people, may tolerate a longer delay. The design tradeoffs in this area are well understood by those skilled in the art.

Once the two frames have been captured, the process 400 moves to a decision step 420 where instructions in the motion sensing module implementing step 420 determine if any difference between the two frames represents motion. A number of image processing techniques are known in the art for detecting motion. These include spatial techniques which compare two images, sometimes pixel by pixel. Other embodiments employ frequency domain techniques, utilizing Fourier transform formulations to detect motion. These and other techniques are known to those of ordinary skill in the art.

If no motion is detected by the process 400 at the decision step 420, then the process 400 discards the first image and stores the second image in step 460. The process 400 then returns to the step 415 to capture an additional image. However, if a determination is made that motion did occur between the first and second images, then the process 400 moves to a step 430 and makes the results of the motion analysis available to other modules of the mobile electronic device. In the embodiment illustrated by FIG. 4, instructions in the motion sensing module implementing process 400 provide motion information to the display manager module 212 and the image sensor manager module 211 in step 430. However, other embodiments of the device may include additional modules that utilize motion status information without departing from the spirit of the invention.

The type of motion status data provided by process 400 can vary across embodiments. In some embodiments, the motion status may be a simple binary status indicator, indicating whether motion was detected (motionStatus=1) or not (motionStatus=0). Other embodiments may provide more detailed status. For example, the motion status may be defined as a scalar number representing the amount of motion detected (for example, with “0” indicating no motion, “1” being slight motion and “10” indicating a high degree of motion). Other embodiments may define a motion status indicating not only the degree of motion, but also in which segments of the image frame motion was detected. An embodiment may divide the image frame into eight octants, with motion status provided as a bit mask indicating the status of each octant, conveniently fitting into a one byte “octant” status. Further embodiments may indicate the direction of motion (left to right, top to bottom, etc).

After process 400 sends motion status information to the display manager module 212 and image sensor manager module 211, process 400 moves to decision state 440, where it determines whether the motion sensing module 210 is configured to interrupt non-image core processing. If it is not so configured, process 400 moves to state 460, discussed in more detail below. If motion sensing module 210 is configured to generate interrupts, process 400 moves to process step 450 and instructions in the motion sensing module generate the appropriate interrupts.

Interrupting non-image core processing as in step 450 provides advantages over traditional software/firmware based communication methods, in that waiting to receive a hardware interrupt reduces power requirements. A shared memory or messaging architecture, as discussed earlier, utilizes battery energy to power a processor running firmware or software. The processor will access a memory, for example RAM or ROM, which also utilizes battery energy to function. The data and address buses linking the processor to the memory also consume power. This is in contrast with an interrupt based communication design as described in this embodiment. A component designed to receive notification of a change in motion status via an interrupt can be completely powered down, except for the minimal power used to detect the interrupt signal.

After process step 450 completes, the process 400 moves to state 460. In state 460, the oldest (first) image is discarded. The process 400 then moves to state 415 in order to capture another image, and the motion sensing process begins again. The process 400 is configured to operate continuously, providing motion status as long as the mobile electronic device is powered on. Thus, the instructions in the motion sensing module implementing process 400 represent one means for analyzing a plurality of frames received by an imaging module from a camera sensor to detect motion in a scene. More generally, a processor executing instructions that compare two images to detect motion represents another means for analyzing a plurality of frames received by an imaging module from a camera sensor to detect motion in a scene.

One with skill in the art will recognize that the specific interrupt architecture implemented by step 450 of process 400 may vary across embodiments. For example, the architecture may be designed such that the process 400 generates an interrupt whenever a change in motion is detected. However, this design of process 400 may generate too many interrupts, and prevent other modules from effectively powering down for any significant length of time, thus reducing any power savings realized from this architecture.

In other embodiments of step 450, more complex thresholding may be employed by the process 400 when determining whether to generate an interrupt. For example, the process 400 may generate an interrupt after the motion status transitions from a particular level of motion to a much greater or much lower level of motion. In some embodiments, these thresholds are determined by the motion sensing module 400. In alternative, more flexible embodiments, the module receiving the interrupt may configure the motion sensing module 400 to interrupt in a manner that meets its particular requirements.

The number of interrupts generated by process 400 may also vary across embodiments. Referring back to FIG. 2, the motion sensing module 210 is illustrated generating an interrupt to the non imaging core functions component 213. However, one skilled in the art will recognize that in alternate embodiments instructions in the motion sensing module 210 may implement variations on process 400 so as to generate multiple interrupts to multiple components. For example, both the display manager module 212 and the image sensor manager module 211 may define individual interrupt lines. Some embodiments may employ interrupt thresholds specific to each interrupt line. For example, the display manager module 212 may request an interrupt when no motion has been detected for an extended period of time, whereas the image sensor manager module 211 may request more frequent interrupts. As shown in FIG. 2, instructions in the motion sensing module 210 may further interrupt other non-image core modules 213 not discussed in detail here.

Modules interrupted by the motion sensing module may be on device 100 or can potentially be located on other devices. For example, in one embodiment, a mobile device provides an external port. The external port would include at least one interrupt line and additional data signaling lines. The interrupt line allows instructions in the motion sensing module to interrupt the external device, in a manner similar to interrupting modules integrated onto the mobile device. The data lines of the port facilitate communication of specific motion status data to the external device. This data is typically received by the external device after the external device is interrupted. Techniques to communicate motion status data over an external port to an external device are well known in the art.

Returning to FIG. 4, alternative embodiments of process 400 may include support for a “professional” or “advanced” mode of operation. This mode assumes a high level of user skill at managing the device's capabilities. When this setting is active, the process 400 may be disabled, perhaps regardless of the amount of time elapsing without user input. While power consumption may be increased, with a corresponding reduction in battery life when using the advanced setting, this setting relies on the user to judge the best trade off between device capabilities and power consumption. Other embodiments of process 400 may perform motion sensing after being activated by a certain period of elapsed time without any user input.

One with skill in the art will recognize the manner in which the motion status is communicated from the motion sensing module 210 to the display manager module 212 and image sensor manager module 211 in step 430 may also vary with embodiments of the invention. For example, a shared memory architecture may be employed, with instructions in the motion sensing module 210 implementing step 430 simply updating a status area in the shared memory. With appropriate locking, instructions in the display manager module 212 and image sensor manager 211 module may simply read the status information at a frequency each module determines.

Alternatively, a messaging architecture may be employed in step 430. In this embodiment, step 430 utilizes a separate messaging system, often provided by the operating system, to send messages to both the image sensor manager module 211 and display manager module 212. In some embodiments, instructions in the motion sending module implementing step 430 send messages containing motion status information to other modules on a periodic basis. In an alternate embodiment, instructions in the display manager module and image sensor manager module send a message to the motion sensing module requesting a motion status update. In step 430, instructions in the motion sensing module 210 then send a reply to the requesting module including the latest motion status information. An embodiment providing a more flexible architecture can employ what is known in the art as an observer pattern or publish/subscribe pattern. With any of the inter-module communication techniques known in the art, instructions in both the image sensor manager module 211 and the display manager module 212 are able to obtain the current motion status so as to support their management functions, described in more detail below.

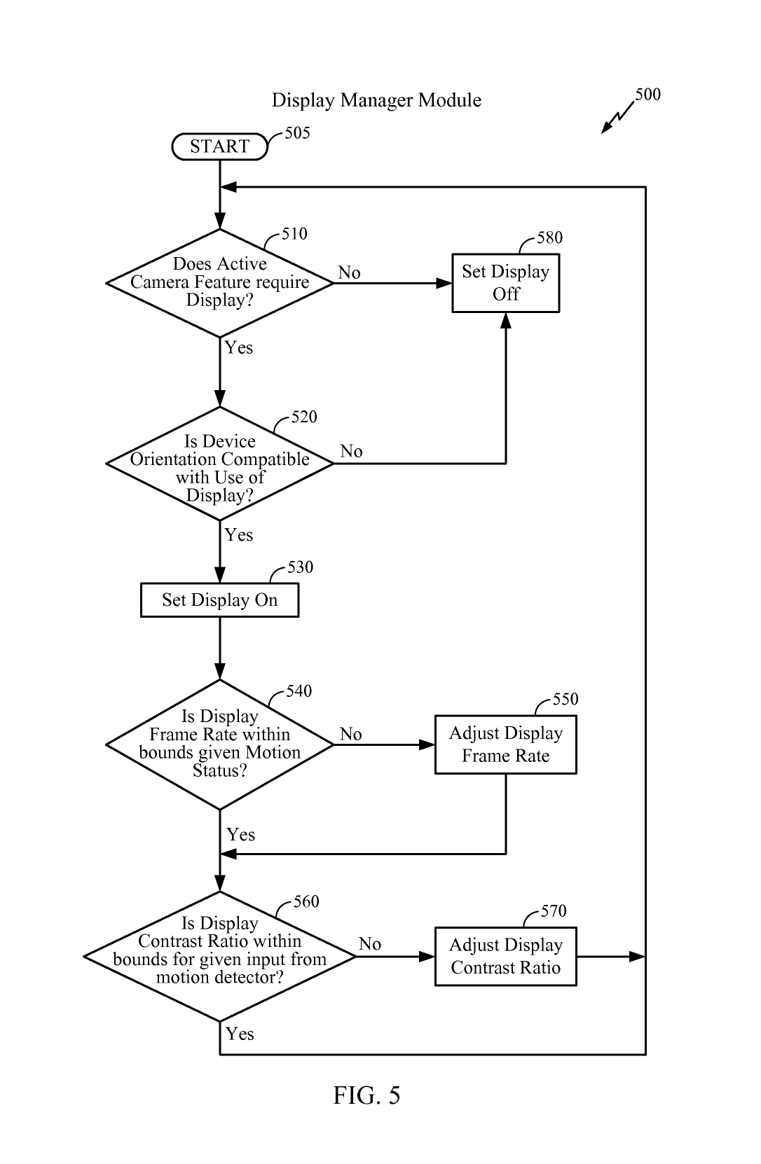

FIG. 5 is a flow chart illustrating a process 500 that runs within one embodiment of the display manager module 212. The process 500 is responsible for minimizing the power consumption of the display device while also ensuring the display provides the performance necessary to ensure a positive user experience.

The process 500 begins at a start state 505 and then moves to determine, in decision step 510, whether an active feature of the mobile device needs the display to be powered on. Some embodiments may rely on an optical viewfinder when in a picture taking mode, with the display powered off to save battery life. If decision step 510 determines there is no need for the display, the process 500 moves to state 580, with the display remaining powered off until a different mode of operation is selected.

If an active function of the mobile device needs the display to be powered on, the process 500 moves from decision step 510 to decision step 520 to determine whether the orientation of the device is compatible with the use of the display. This step of the process 500 is designed to optimize power usage when the device has been placed, display side down, on a horizontal surface such as a table top. In this situation, there is no need to provide power to the display device as it is incapable of being viewed by a user.

When instructions in the display manager module running process 500 determine the device orientation is incompatible with use of the display in decision step 520, the process 500 moves to step 580. In step 580 the display is powered down. In some embodiments of process 500, instructions performed in step 580 slowly reduce the brightness of the display. Gradually reducing the brightness of the display provides the user with early indications that the display is shutting down, providing a warning to the user of an impending shutdown of the display. Such a warning allows the user to prevent the display shutdown if the display manager module has incorrectly determined the device's current usage.

Once the display has been powered off in step 580, the process 500 moves back to step 510 to restart the process. Process 500 continues to monitor the device's orientation, so as to reactivate the display should the device's orientation change to one compatible with usage of the display. The iterative character of the process 500, illustrated in the flowchart of FIG. 5 enables the ability to continually monitor the position of the device. Since the process described repeats continuously, process 500 is frequently reevaluating whether the orientation of the device is compatible with use of the display.

If a decision is made in decision step 520 of process 500 that the device orientation is compatible with use of the display, the process 500 moves from decision step 510 to process step 530. In step 530 the process 500 ensures the display is powered back on.

Next, the process 500 moves to decision step 540. Decision step 540 is the first step of process 500 that utilizes motion status information from the motion sensing module 210 to tune display parameters. The displays used in modern mobile devices have become increasingly powerful, supporting high resolutions and frame rates. While this provides an exciting user experience, it also consumes significant power, resulting in lower battery life. In one illustrated embodiment of process 500 the process 500 recognizes that power consumption can be optimized by tuning the capabilities of the display based on the level of motion the display communicates to a user. For example, scenes with relatively little motion may have acceptable image quality at a frame rate of 12 FPS (frames per second), while scenes with a high degree of motion (a high school football game for example) may call for frame rates of 24 FPS or greater to provide sufficient image quality.

TABLE 1

| Level of Motion | Frame Rate | Power Usage |
|---|---|---|
| None | 12 Frames Per Second | ? |
| Low | 12 Frames Per Second | ? |
| Medium | 24 Frames Per Second | ? |
| High | 48 Frames Per Second | ? |

Table 1 illustrates an example of thresholds utilized by process 500 to determine the appropriate frame rate of a display, as in step 540 of FIG. 5. In this embodiment, the motion sensing module 210 provides four levels of motion status, represented by the left most column of Table 1. Based on the current motion status, instructions in the display manager module 212 implementing process 500 in step 540 consult table one and compare the current frame rate with the frame rate corresponding to the current level of motion.

If the current display parameters fall outside the thresholds defined for the current motion status, process 500 moves from decision step 540 to process step 550. In one embodiment, at step 550, instructions in the display manager module 212 may synchronously update the display's frame rate as motion updates are received from the motion sensing module. When this approach is used, the display manager module 212's design relies on the motion sensing module 210 to incorporate internal smoothing operations to “average” motion over a period of time before alerting it of a particular motion status. Integrating this capability into the motion sensing module 210 centralizes the capability, enabling it to be leveraged by other modules included in the electronic mobile device. This may simplify the design of other device modules, saving product development time while reducing code size and corresponding hardware costs.

Alternatively, instructions run in step 550 may implement their own heuristics to “smooth” the adjustment of display frame rates. This may be necessary if smoothing procedures implemented by instructions in the motion sensing module 210 result in a frequency of frame rate changes to the display that provide an unacceptable user experience. For example, the process 500 at step 550 may generate a moving average of the motion status received from the motion sensing module. Updates to display frame rates can then be based on the moving average. Such an embodiment of step 550 avoids increasing the frame rates based on short term, “fleeting” motion detected by the motion sensing module, preventing flicker in the displayed image as the frame rate is updated.

In another embodiment, the frame rate of the display may be immediately increased at step 550 when motion is detected, in a specific attempt to capture short term “fleeting” motion. In this embodiment of step 550, reduction of the display frame rate would be reduced gradually over time as no additional motion is detected. One skilled in the art would understand a variety of smoothing procedures are possible, and the selection of an procedure will depend on the specific design goals of a particular embodiment of a mobile device.

Once the process 500 has ensured the display's frame rate is set as defined by Table 1, process 500 moves to state 560, either from decision state 540 or process state 550. In decision step 560, the level of motion detected by instructions in the motion sensing module 210 is used to determine the display's contrast ratio.

This technique recognizes that a higher contrast ratio assists with the visual discrimination of fast moving scenes, albeit at a higher power consumption. A high contrast ratio is less valuable in the display of static scenes or scenes with relatively little motion. As such, reducing contrast ratio will reduce power consumption of the mobile device with a negligible effect on user experience, at least in some circumstances.

TABLE 2

| Level of Motion | Contrast Ratio | Power Usage |
|---|---|---|
| None | 3:1 | ? |
| Low | 7:1 | ? |
| Medium | 25:1 | ? |
| High | 800:1 | ? |

Table 2 illustrates thresholds utilized during execution of one embodiment of decision step 560 to control the contrast ratio of the display. At step 560, process 500 determine whether the current contrast ratio of the display is appropriate given the level of motion.

While Table 2 defines specific contrast ratios for particular levels of motion, some embodiments of step 560 may incorporate interpolation techniques to gradually transition from one contrast ratio to another, providing a more seamless visual experience for a user.

If a determination is made at decision step 560 that the display parameters are not within the thresholds, process 500 moves to step 570 wherein the contrast ratio is set to the values provided by Table 2. It should be realized that the contrast ratio can be set either quickly or slowly to provide an intuitive visual indication to the user that the display is shutting down. A gradual transition from full brightness to a dark screen provides advance notice to the user of the impending shutdown, and an opportunity for the user to react and prevent the shutdown of the display before it disrupts their use of the mobile device. Thus, the instructions running within the display manager module implementing process 500 comprise one means for making an adjustment to a feature of an imaging apparatus if no motion is detected in the scene. More generally, a processor r executing instructions that verify device usage or configuration in order to appropriately configure an electronic display represents another means for making an adjustment to a feature of an imaging apparatus if no motion is detected in the scene.

After the display parameters are moved to within the thresholds defined by Table 2, the process 500 returns to decision step 510 to determine if the active camera feature utilizes display. This feature makes the display manager module iterative in nature, providing for continuous reevaluation of the device environment in order to determine whether the display settings are optimal.

While FIG. 5 illustrates an iterative embodiment of the process 500, alternative embodiments are also contemplated. For example, when the “advanced” feature described in reference to the motion sensing module 210 is activated, process 500 may support the ability to disable some features of the embodiment illustrated in FIG. 5, such that display parameters are controlled primarily by the configured display settings, and not by the level of motion detected and/or camera orientation.

While disabling the display based on device orientation presents power saving opportunities, it also introduces the possibility of deciding to power down the display at an inappropriate time, frustrating a user's legitimate use of the device. To prevent this, the display manager module 500 may include instructions to implement certain intelligent procedures. For example, the display manager module 500 may rely on timing thresholds to distinguish between a mobile device placed display side down on a table top and a mobile device held skyward to photograph a mural on a ceiling, or a full moon in the night sky. To make such a distinction, the process 500 may utilize a simple heuristic to delay a display device power down until the device remains in a horizontal position for a predetermined period of time. This approach assumes a user's use of the device in a vertical orientation is unlikely to continue longer than the predetermined period of time, whereas a device placed on a tabletop may remain for a longer period.

Those skilled in the art will also recognize alternate embodiments of process 500 that incorporate more intelligent procedures for detection of the device's orientation. For example, one alternate embodiment utilizes a built in orientation sensor to detect the natural shaking that occurs when a device is held by a user. In this embodiment, the minuet changes in orientation caused by the shaking of a hand-held device resets a delay timer tracking the time the device is in a vertical position. With this approach, the minuet changes in orientation prevent the process 500 from falsely determining that the device has been placed on a table top, when it is actually held vertically by a user.

Other embodiments may rely on data from a built in accelerometer. This data may be used alone or in combination with data from an orientation sensor. Data from the accelerometer provides an indication of the device's stability. When the device is held by a user, the natural shaking of the user's hand will be detected by the accelerometer and registered as small accelerations in random directions. When the device is placed on a table top, the accelerometer will register zero acceleration in all dimensions. Utilization of an accelerometer to augment input from the orientation detector is especially useful when the mobile device's orientation sensor is optimized for low cost, and may not provide the precision necessary to detect small changes in orientation that occur when the mobile device is held by a user.

Those skilled in the art will recognize alternate embodiments may include, for example, input from an ambient light sensor. An ambient light sensor can be used to determine whether to adjust the contrast ratio of the display. For example, if the mobile device is operated under conditions of high ambient lighting, the process 500 can determine that a higher contrast ratio is needed to ensure adequate visibility of the displayed image. Conversely, if the mobile device is operated in low light conditions, instructions in the process can determine that a lower contrast ratio provides an opportunity to save power while also providing a more pleasant visual experience. A lower contrast ratio may avoid eye strain, especially in dark rooms where a user's eyes have acclimated to the lack of light, and are then forced to focus on a too bright display screen. Note that integration of an ambient light sensor into the imaging device provides other benefits, such as assisting in the calculation of exposure control parameters for an integrated imaging sensor.

Alternate embodiments of process 500 may include support for several distinct advanced settings. For example, one advanced setting may disable motion activated changes based on input from the motion sensing module 210, while a separate advanced setting may disable changes to display parameters based on accelerations or device orientation. Such a second advanced setting may be necessary to ensure adequate device performance in unique situations, for example to facilitate the capture of “star tracks” while using a tri-pod to hold the camera steady. Such a use case might cause the display to be disabled by the display manager module when it detects a vertical orientation coupled with a lack of motion. Furthermore, the relatively small amount of motion in the night sky may shutdown mobile device components if the motion sensing module 210 remains active. These challenges reinforce the need for the advanced settings described earlier with regards to the motion sensing module, and the potential need to extend them to cover orientation, acceleration, and ambient light based changes to display parameters.

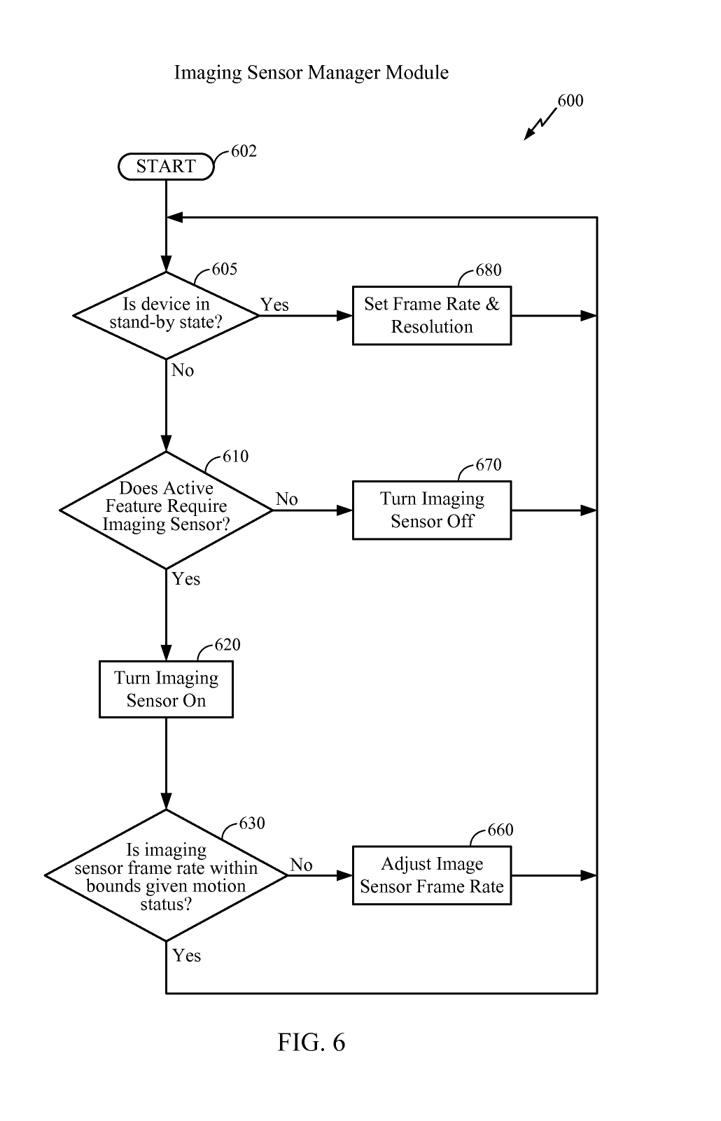

FIG. 6 is a flow chart illustrating a process 600 that runs within one embodiment of the imaging sensor manager module 211 and optimize the power consumption of a camera sensor while also ensuring the camera sensor meets the imaging needs of the mobile device user. The process 600 begins at start state 602 and then moves to determine in step 605 whether the device is in a standby state. In the standby state, the majority of device functions are powered off, but the device is capturing images using a core process associated with the imaging sensor to provide a motion detection capability. If the process 600 determines that the device is in a stand-by state in decision step 605, then process 600 moves to step 680 wherein a particular image sensor frame rate and resolution are set. The specific frame rate and resolution may vary with different embodiments of the imaging sensor 103 and device 100. However, because motion can be detected with relatively low resolutions and frame rates, the imaging sensor 203 may consume significantly less power when the device is in the motion stand-by state.

If decision step 605 determines that the device is not in a stand-by state, the process 600 moves to decision state 610 to determine whether the imaging sensor 203 is needed to support currently active features of the device. For example, if the device is a handheld camera, and the user has placed the camera in a picture review mode, there may be no need to power the image sensor.

If there is no active feature requiring use of the imaging sensor in decision step 610, the process 600 moves to step 670 and turns off the imaging sensor. Process 600 then loops back to decision step 605, and the process 600 repeats.

If active features utilize the imaging sensor at decision step 610, then the process 600 moves to step 620 wherein the process 600 ensures that the imaging sensor is turned on. Process 600 then moves to decision state 630 to determine if the frame rate of the imaging sensor 203 is appropriate for the current motion in the scene.

TABLE 3

| | Frame Rate of | Power |
|---|---|---|
| Motion Level | Imaging Sensor | Requirements (mW) |
| None | .5 Frames Per | 32 |
| | Second | |
| Low | 30 Frames Per | 170 |
| | Second | |
| Medium | 60 Frames Per | 310 |
| | Second | |
| High | 120 Frames Per | 590 |
| | Second | |

Table 3 represents one possible embodiment of a set of thresholds used in step 630 to determine if the imaging sensor frame rate is within the correct bounds given the amount of detected motion. As seen from the table of thresholds, when instructions in the motion sensing module 210 are not detecting motion, a minimal frame rate is needed. When no motion is present, frequent frame captures by the imaging sensor 203 will result in duplicate frames, since the scene appears the same with each frame. If process 600 determines that the current frame rate is outside the thresholds defined in Table 3, process 600 moves to step 660 to adjust the image sensor frame rate to be aligned with the detected motion. In one embodiment, the process 600 lowers the frame rate to a predetermined minimum level. In another embodiment, the process 600 raises the frame rate to a predetermined maximum. Thus, the imaging sensor manager, which contains instructions that execute process 600, comprises one means for making an adjustment to a feature of an imaging apparatus if no motion is detected in the scene. The process 600 then returns to decision state 605 to determine if the device is in a standby mode. Following this step the process 600 then repeats.

In some embodiments of step 660, the frame rate should be high enough to support a display that is refreshed synchronously with the capture of image frames by the imaging sensor. This ensures a displayed image with acceptable image quality.

In alternative embodiments, the process 600 reduces frame rates below the minimum display frame rates, because the image pipeline duplicates frame data to ensure adequate display image quality. Very low frame rates are possible in this embodiment, for example, image frames of one or fewer frames per second. However, since many electronic displays use a frame rate of at least 30 FPS to maintain acceptable image quality, instructions in the image pipeline refresh the display with duplicate data until the next new frame is captured. In this example, the image pipeline would duplicate each image frame provided by the imaging sensor 29 times per second. This strategy provides the appearance of a live picture, but provides significantly reduced power consumption when compared to the power needed to support a true live image. The lack of motion in the scene enables this power savings, because although the image is not truly live, no data is lost and a satisfying user experience is maintained.

Along with supporting the display of a live image, the frame rate of the image sensor set by step 660 may also provide adequate notice to the image processing module if and when motion begins to occur in a scene. The average time for the mobile device to detect motion will be one half the time interval between frames. For example, if the frame rate is one frame per second, the average time for motion detection is one half second. However, the maximum time to detect motion will be one second, assuming no delays in image processing. Depending on the response time requirements of the mobile device, a designer will choose the minimum frame rate by trading off device response time and battery life.

Those having skill in the art will further appreciate that the various illustrative logical blocks, modules, circuits, and process steps described in connection with the implementations disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. One skilled in the art will recognize that a portion, or a part, may comprise something less than, or equal to, a whole. For example, a portion of a collection of pixels may refer to a sub-collection of those pixels.

The various illustrative logical blocks, modules, and circuits described in connection with the implementations disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or process described in connection with the implementations disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of non-transitory storage medium known in the art. An exemplary computer-readable storage medium is coupled to the processor such the processor can read information from, and write information to, the computer-readable storage medium. In the alternative, the storage medium may be integral to the processor. The processor and the storage medium may reside in an ASIC. The ASIC may reside in a user terminal, camera, or other device. In the alternative, the processor and the storage medium may reside as discrete components in a user terminal, camera, or other device.

Headings are included herein for reference and to aid in locating various sections. These headings are not intended to limit the scope of the concepts described with respect thereto. Such concepts may have applicability throughout the entire specification.

The previous description of the disclosed implementations is provided to enable any person skilled in the art to make or use the present invention. Various modifications to these implementations will be readily apparent to those skilled in the art, and the generic principles defined herein may be applied to other implementations without departing from the spirit or scope of the invention. Thus, the present invention is not intended to be limited to the implementations shown herein but is to be accorded the widest scope consistent with the principles and novel features disclosed herein.

1. A method of managing power consumption in a mobile device having an imaging sensor and a display, comprising:
capturing images of a scene of interest using the imaging sensor;
detecting a level of motion in the scene of interest; and
managing power consumption of the mobile device by adjusting the display frame rate or the display contrast ratio of the display based on the level of detected motion.

2. The method of claim 1, wherein managing the power consumption comprises adjusting a resolution of the imaging sensor based on the detected level of motion.

3. The method of claim 2, further comprising upconverting the frame rate of the imaging sensor to display the scene on the display at a frame rate above a threshold when the imaging sensor frame rate is below the threshold.

4. The method of claim 1, wherein managing the power consumption comprises adjusting the display contrast ratio based on input from an ambient light sensor.

5. The method of claim 1, wherein managing the power consumption comprises progressively adjusting the display contrast ratio in response to detecting a plurality of motion levels below a threshold.

6. The method of claim 5, wherein progressively adjusting the display contrast ratio comprises adjusting the contrast ration to a predefined contrast ratio based on detecting a level of motion.

7. The method of claim 1, wherein detecting a level of motion in the scene comprises determining a moving average level of motion in the scene.

8. The method of claim 7, wherein managing the power consumption comprises adjusting the display frame rate or the display contrast ratio based on the moving average level of motion in the scene.

9. The method of claim 1, wherein managing the power consumption comprises adjusting the display frame rate to a predefined display frame rate.

10. The method of claim 1, wherein managing the power consumption comprises progressively reducing the display frame rate in response to detecting a plurality of motion levels below a threshold.

11. The method of claim 1, further comprising determining a period of time has elapsed without user input to the device and detecting the level of motion in the scene in response to the determination.

12. A mobile electronic device, comprising:
an imaging sensor;
an electronic display;
a processor; and
a memory, operably connected to the processor, and storing:
an imaging sensor manager module comprising instructions that configure the processor to capture images of a scene of interest using the imaging sensor;
a display manager module comprising instructions that configure the processor to display images on the electronic display based on images from a scene of interest captured by the imaging sensor;
a motion sensing module comprising instructions that configure the processor to detect a level of motion in the scene of interest,
wherein the display manager module comprises further instructions that configure the processor to manage power consumption of the mobile electronic device by adjusting a display frame rate or a display contrast ratio based on the level of detected motion.

13. The mobile electronic device of claim 12, wherein the display manager module comprises further instructions that configure the processor to adjust a resolution of the imaging sensor based on the level of detected motion.

14. The mobile electronic device of claim 12, wherein the imaging sensor manager module comprises instructions that configure the processor to upconvert a frame rate of the imaging sensor to display the scene on the display at a frame rate above a threshold when the imaging sensor frame rate is below the threshold.

15. The mobile electronic device of claim 12, wherein the display manager module comprises instructions that configure the processor to manage power consumption by adjusting the display contrast ratio based on input from an ambient light sensor.

16. The mobile electronic device of claim 12, wherein the display manager module comprises instructions that configure the processor to manage power consumption by progressively adjusting the display contrast ratio in response to detecting a plurality of motion levels below a threshold.

17. The mobile electronic device of claim 16, wherein the display manager module comprises instructions that configure the processor to manage power consumption by adjusting the display contrast ratio to a predefined contrast ratio based on the level of motion.

18. The mobile electronic device of claim 12, wherein the display manager module comprises instructions that configure the processor to determine a moving average level of motion in the scene, and manage power consumption by adjusting the one or more of the display frame rate and the display contrast ratio based on the moving average.

19. The mobile electronic device of claim 12, wherein the display manager module comprises instructions that configure the processor to manage power consumption by adjusting the display frame rate to a predefined frame rate based on the level of motion detected.

20. The mobile electronic device of claim 12, wherein the display manager module comprises instructions that configure the processor to manage power consumption by progressively reducing the display frame rate in response to detecting a plurality of motion levels below a threshold.

21. The mobile electronic device of claim 12, wherein the display manager module comprises instructions that configure the processor to:
determine a period of time has elapsed without user input to the device; and
detect the level of motion in the scene in response to the determination.

22. A mobile electronic device that manages power consumption, comprising:
means for imaging;
means for capturing images of a scene of interesting using the means for imaging;
means for detecting a level of motion in the scene of interest; and
means for managing power consumption of the mobile electronic device by adjusting one or more of a display frame rate and a display contrast ratio of the means for displaying based on the level of motion detected.

23. The mobile electronic device of claim 22, wherein the means for adjusting is an electronic processor executing instructions stored in a display manager module.

24. A computer readable storage medium comprising instructions that when executed cause a processor to perform a method of managing power consumption in a mobile electronic device having an imaging sensor and a display, the method comprising:
capturing images of a scene of interest using the imaging sensor;
detecting a level of motion in a scene of interest captured by the imaging sensor; and
managing power consumption of the mobile device by adjusting one or more of a display frame rate and a display contrast ratio of the display based on the level of detected motion.

25. The computer readable storage medium of claim 24, wherein managing the power consumption comprises adjusting a resolution of the imaging sensor based on the level of detected motion.

26. The computer readable storage medium of claim 24, the method further comprising upconverting a frame rate of the imaging sensor to display the scene on the display at a frame rate above a threshold when the imaging sensor frame rate is below the threshold.

27. The computer readable storage medium of claim 24, wherein managing the power consumption comprises adjusting the display contrast ratio further based on input from an ambient light sensor.
